(19) United States
(12) Patent Application Publication
(10) Pub. No.: US 2013/0279852 A1
(43) Pub. Date: Oct. 24, 2013

(54) PAIRED-OPTICAL FIBER PROBE WITH A SINGLE BODY LENS AND METHOD FOR MANUFACTURING SAME

(71) Applicants: Ki Soo Chang, Daejeon-Si (KR); Seon Young Ryu, Chungcheongbuk-do (KR); Hae Young Choi, Chungcheongbuk-do (KR); Geon Hee Kim, Chungcheongbuk-do (KR)

(72) Inventors: Ki Soo Chang, Daejeon-Si (KR); Seon Young Ryu, Chungcheongbuk-do (KR); Hae Young Choi, Chungcheongbuk-do (KR); Geon Hee Kim, Chungcheongbuk-do (KR)

(73) Assignee: KOREA BASIC SCIENCE INSTITUTE, Daejeon-Si (KR)

(21) Appl. No.: 13/991,004

(22) PCT Filed: Dec. 1, 2011
(86) PCT No.: PCT/KR2011/009269

§ 371 Date: Jul. 11, 2013

(30) Foreign Application Priority Data
Dec. 1, 2010 (KR) 10-2010-0121596

(51) Int. Cl. G02B 6/32

(52) U.S. Cl. CPC G02B 6/32
USPC 385/33; 264/1.26

(57) ABSTRACT

The present invention relates to a paired optical fiber probe with a single body lens and a method for manufacturing the same. The probe includes a first optical fiber, a second optical fiber arranged in parallel with the first optical fiber, and an optical fiber lens which is formed by heating a predetermined region including one end of the first optical fiber and one end of the second optical fiber using a heating means such that ends of the first and second optical fibers are integrally connected to each other, the optical lens having a lens surface with a predetermined radius of curvature. Thus, an optical coupling efficiency can be effectively improved through a simple manufacturing process, and the probe of the present invention can be utilized in a fluorescence spectroscopic system or an imaging system adopting reflectometry.

### TECHNICAL FIELD

The present invention relates to a paired optical fiber probe with a single body lens and a method for manufacturing the same, and more particularly, to a paired optical fiber probe with a single body lens, whereby an optical fiber lens is formed integrally with ends of at least two strands of paired optical fiber using a heating means so that an optical coupling efficiency can be effectively improved through a simple manufacturing process, and the paired optical fiber probe can be utilized in a fluorescence spectroscopic system or a reflector type imaging system.

### BACKGROUND ART

In general, optical fiber lenses are used to improve an optical coupling efficiency and to make a small size module in optical coupling between a light source or an optical element and an optical fiber, or in optical coupling between two optical fibers.

Recently, these optical fiber lenses have been widely utilized in an imaging system, or a laser treatment device other than optical communications. In particular, optical fiber probes have been used to miniaturize an imaging system, for example, in a fluorescence spectroscopic system or a reflector type imaging system. The simplest method to miniaturize a fluorescence spectroscopic system or a reflector type imaging system is to simultaneously transmit an excitation beam and a fluorescence signal through one optical fiber. However, in such a structure, a bulk optical coupler and lenses are required to separate and transmit/receive the excitation beam and the fluorescence signal from sample. The biggest problem of this technique is that the excitation beam and the fluorescence signal are transmitted via the same path. Thus, since it is hard to remove fluorescence noise generated by the excitation from the optical fiber, a signal-to-noise ratio (SNR) of the fluorescence signal is very low.

Various techniques according to the related art have been used to try to solve this problem. Three representative techniques are described below.

The first technique is to use two independent strands of a paired optical fiber for an excitation beam and for detecting a fluorescence beam, respectively. In the first technique, ends of the two strands of optical fiber are simply cleaved and attached in parallel, or are polished to a predetermined angle. In the former structure, manufacturing process is simple yet the optical coupling efficiency of the fluorescence signal is very low. Thus the method is limited to apply into a sample that generates a very strong fluorescence signal only. In the latter structure, the optical coupling efficiency is improved by about two times over the former structure; however, two optical fibers should be polished to an accurate angle and thus a manufacturing process is complicated.

The second technique is to use an optical fiber probe in which a bulk ball lens is disposed at ends of several strands of optical fiber so as to improve the fluorescence signal detecting efficiency and depth-resolving ability. In the technique, since a micro-sized ball lens is used to reduce the size of an optical fiber probe, it is very difficult to perform optical arrangement between several strands of optical fiber and the ball lens. Furthermore, despite using the micro-sized ball lens, the size of the optical fiber probe is still bulk so that it cannot apply into optical fiber system directly and results in requiring precise packaging.

The third technique is to use a specially fabricated double-cladding optical fiber. In the technique, an optical fiber probe has simplest structure, since a probe is manufactured by using only one strand of optical fiber. Also, since an excitation beam is transmitted to an optical fiber core and a fluorescence signal is separated from the excitation beam using an inner cladding optical fiber having a large diameter, fluorescence noise can be removed from the optical fiber, and the optical coupling efficiency is high. However, the special optical fiber coupler is required to separate the excitation beam and the fluorescence signal. Also, the reported optical coupling efficiency of the special optical fiber coupler was less than about 40%, and thus much optical loss occurs.

### DISCLOSURE

### Technical Problem

The present invention provides a paired optical fiber probe with a single body lens, whereby an optical fiber lens is formed integrally with ends of at least two strands of paired optical fiber using a heating means. Because of those, we could solve the problems of an existing paired optical fiber probe, such as low optical coupling efficiency, structural complexity, difficulty of optical arrangement and packaging, need for a specific optical element, and manufacturing difficulty. Furthermore, the optical coupling efficiency can be effectively improved through a simple manufacturing process and the paired optical fiber probe can be utilized in a fluorescence spectroscopic system or a reflector type imaging system.

The present invention also provides a paired optical fiber probe with a single body lens having a high optical coupling efficiency and capable of being manufactured with a small size, and a method for manufacturing the same.

The present invention also provides a paired optical fiber probe that is capable of resolving depth when the paired optical fiber probe is utilized in a fluorescence spectroscopic system or an imaging system adopting reflectometry, and a method for manufacturing the same.

### Technical Solution

One aspect of the present invention provides a paired optical fiber probe with a single lens body, including: a first optical fiber; a second optical fiber arranged in parallel with the first optical fiber; and an optical fiber lens which is formed by heating a predetermined region including one end of the first optical fiber and one end of the second optical fiber using a heating means such that ends of the first and second optical fibers are integrally connected to each other, the optical lens having a lens surface with a predetermined radius of curvature.

The first and second optical fibers may be arranged in such a way that portions of lateral sides of the first and second optical fibers are in line- or surface-contact with each other.

The first and second optical fibers may be fixed by applying a predetermined adhesive to a portion in which the first and second optical fibers are arranged such that portions of lateral sides of the first and second optical fibers are in line- or surface-contact with each other.

The heating means may be one selected from the group consisting of arc-discharge, an oxygen-hydrogen flame, and a CO₂ laser.

The first and second optical fibers may have the same or different structures and may be at least one selected from the group consisting of a single mode fiber (SMF), a multi-mode fiber (MMF), a photonic crystal fiber, and a double-cladding optical fiber.

Another aspect of the present invention provides a method for manufacturing a paired optical fiber probe, the method including: (a) providing first and second optical fibers; (b) arranging the first and second optical fibers in parallel with each other; and (c) forming an optical fiber lens by heating a predetermined region including one end of the first optical fiber and one end of the second optical fiber using a heating means such that ends of the first and second optical fibers are integrally connected to each other, the optical lens having a lens surface with a predetermined radius of curvature.

In (b), the first and second optical fibers may be arranged in parallel with each other in such a way that portions of lateral sides of the first and second optical fibers are in line- or surface-contact with each other.

The method may further include fixing the first and second optical fibers by applying a predetermined adhesive to a portion in which the first and second optical fibers are arranged such that portions of lateral sides of the first and second optical fibers are in line- or surface-contact with each other.

The method may further include, after fixing the first and second optical fibers, cleaving the first and second optical fibers in such a way that cross-sections of ends of the first and second optical fibers are parallel to each other.

The heating means may be one selected from the group consisting of arc-discharge, an oxygen-hydrogen flame, and a CO₂ laser.

The first and second optical fibers may have the same or different structures and may be at least one selected from the group consisting of a single mode fiber (SMF), a multi-mode fiber (MMF), a photonic crystal fiber, and a double-cladding optical fiber.

### Effects of the Invention

As described above, in a paired optical fiber probe with a single body lens and a method for manufacturing the same according to the present invention, an optical fiber lens is formed integrally with ends of at least two strands of paired optical fiber using a heating means. With this invention, an optical coupling efficiency can be effectively improved through a simple manufacturing process and the paired optical fiber probe can be utilized in a fluorescence spectroscopic system or a reflector type imaging system.

### DESCRIPTION OF DRAWINGS

FIG. 1 is a cross-sectional view of a paired optical fiber probe with a single body lens according to an embodiment of the present invention.

FIG. 2 is a view illustrating a method for manufacturing a paired optical fiber probe with a single body lens, according to an embodiment of the present invention.

FIG. 3 is a graph showing the result of measuring a change of optical power according to a separation distance between a lens surface and a reflection mirror of a paired optical fiber probe with a single body lens according to an embodiment of the present invention.

FIGS. 4A through 4D illustrate fluorescence signals measured using an arbitrarily manufactured sample and paired optical fiber probes with single body lenses manufactured according to an embodiment of the present invention.

FIG. 5 is a view illustrating the concept of a fluorescence spectroscopic system for measuring a fluorescence signal from a sample using a paired optical fiber probe with a single body lens according to an embodiment of the present invention.

FIG. 6 is a graph showing the result of comparing a paired optical fiber probe with a single body lens according to an embodiment of the present invention with a paired optical fiber probe having no lens with respect to a reflection signal measured from a mirror using the fluorescence spectroscopic system of FIG. 5.

FIG. 7 is a graph showing the result of comparing a paired optical fiber probe with a single body lens according to an embodiment of the present invention with a paired optical fiber probe having no lens with respect to a fluorescence signal measured from a ginkgo leaf using the fluorescence spectroscopic system of FIG. 5.

### MODES OF THE INVENTION

Hereinafter, exemplary embodiments of the present invention will be described in detail. However, the present invention is not limited to the exemplary embodiments disclosed below, but can be implemented in various forms. The following exemplary embodiments are described in order to enable those of ordinary skill in the art to embody and practice the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used here, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

Hereinafter, the present invention will be described in detail by explaining exemplary embodiments of the invention with reference to the attached drawings. Elements that appear in more than one drawing or are mentioned in more than part of the detailed description are consistently denoted by the same respective reference numerals.

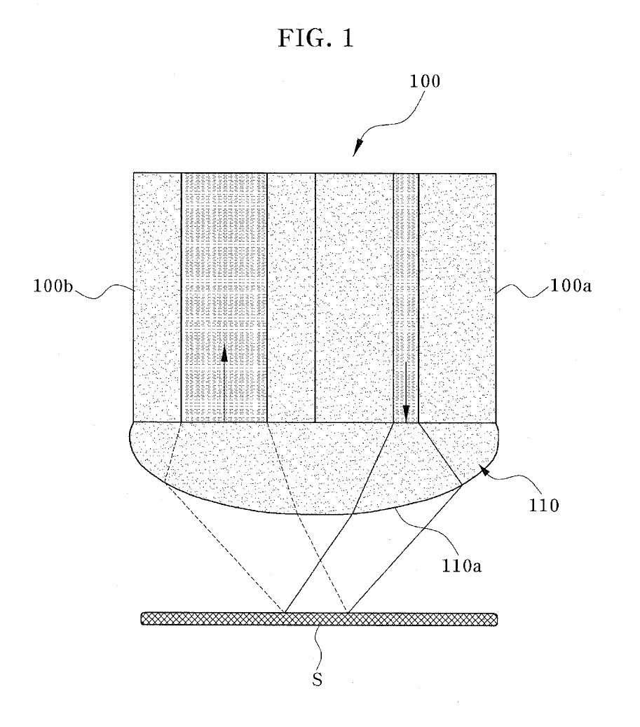

FIG. 1 is a cross-sectional view of a paired optical fiber probe with a single body lens according to an embodiment of the present invention.

Referring to FIG. 1, a paired optical fiber probe with a single body lens 100 according to an embodiment of the present invention includes first and second optical fibers 100a and 100b and an optical fiber lens 110.

Here, the first and second optical fibers 100a and 100b are arranged in parallel with each other, and one side of the first optical fiber 100a and one side of the second optical fiber 100b may be in line- or surface-contact with each other.

The first optical fiber 100a includes a single mode fiber (SMF) for an excitation beam, and the second optical fiber 100b includes a multi-mode fiber (MMF) so as to receive a collection beam. Thus, the reason why the single mode fiber (SMF) is used for the excitation beam is to reduce the size of a beam at a focus. The reason why the multi-mode fiber (MMF) is used to receive the collection beam is that, since the core of the MMF is large, many beams may be received. However, aspects of the present invention are not limited thereto, and a paired optical fiber probe may be manufactured using various types of optical fibers having various sizes.

That is, the first and second optical fibers 100a and 100b may be configured to have the same or different structures. For example, the first and second optical fibers 100a and 100b may include at least one from among an SMF, a MMF, a photonic crystal fiber, and a double-cladding optical fiber.

For example, the photonic crystal fiber has multiple air holes formed around the core, unlike in a general SMF, and is also called a holey fiber or microstructured fiber.

In the photonic crystal fiber, multiple air holes (for example, 2 to 1000) are regularly or irregularly arranged along a cladding of an optical fiber, and there is no air hole in the core of the optical fiber, or an air hole exists in the core of the optical fiber but the size of the air hole is different from the sizes of peripheral air holes in the core.

The optical fiber lens 110 is configured in such a way that ends of the first and second optical fibers 100a and 100b are integrally connected to each other. The optical fiber lens 110 includes a lens surface 110a having a predetermined radius of curvature at an end of the optical fiber lens 110.

The optical fiber lens 110 is configured in such a way that light guided along the core of the first optical fiber 100a is extended to have a sufficient size on the lens surface 110a, and the extended light is refracted at the lens surface 110a and directed toward the center of the paired optical fiber probe 100. Also, the optical fiber lens 110 allows a beam reflected from a sample S to be refracted at the lens surface 110a and directed toward the second optical fiber 100b.

The optical fiber lens 110 having the above configuration may be formed integrally with the ends of the first and second optical fibers 100a and 100b using arc-discharge or a high-temperature heating method using laser, for example.

In the operating principle of the paired optical fiber probe with a single body lens 100 having the above configuration illustrated in FIG. 1, light generated in an external light source unit is transferred via the core of the first optical fiber 100a that is an SMF, a beam transferred via the core of the first optical fiber 100a is extended at the optical fiber lens 110, and the extended beam is refracted at the lens surface 110a formed at the end of the optical fiber lens 110 and directed toward the center of the paired optical fiber probe 100. In this case, a beam reflected from the sample S is transferred via the core of the second optical fiber 100b that is an MMF through the optical fiber lens 110.

In FIG. 1, the paired optical fiber probe has been implemented using two strands of optical fiber, i.e., the first and second optical fibers 100a and 100b; however, aspects of the present invention are not limited thereto, and the paired optical fiber probe may also be implemented by contacting two or more strands of optical fiber with each other.

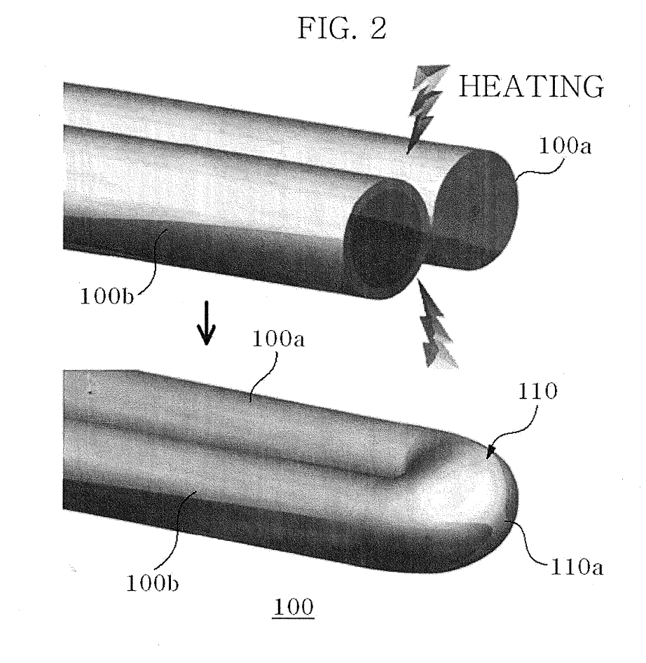

FIG. 2 is a view illustrating a method for manufacturing a paired optical fiber probe with a single body lens, according to an embodiment of the present invention.

Referring to FIG. 2, the method for manufacturing a paired optical fiber probe with a single body lens, according to an embodiment of the present invention, includes, first, arranging two strands of optical fiber, i.e., first and second optical fibers 100a and 100b, in parallel with each other, and then fixing the first and second optical fibers 100a and 100b by applying a predetermined adhesive to portions of lateral sides of the first and second optical fibers 100a and 100b.

In this case, the first and second optical fibers 100a and 100b may be arranged in parallel with each other so that portions of lateral sides of the first and second optical fibers 100a and 100b may be in line- or surface-contact with each other, and it is important that there is no gap between the first and second optical fibers 100a and 100b.

Next, after the first and second optical fibers 100a and 100b are fixed, for example, the first and second optical fibers 100a and 100b are cleaved using an optical fiber cleaver such that cross-sections of ends of the first and second optical fibers 100a and 100b are parallel to each other.

In this case, the flatness of the ends of the first and second optical fibers 100a and 100b is important. If an inclination is formed at the cleaved surface of the first and second optical fibers 100a and 100b, an optical fiber lens having a crooked shape is formed so that a desired type of paired optical fiber probe cannot be manufactured.

Last, a predetermined region including the ends of the first and second optical fibers 100a and 100b is heated using a heating means, thereby forming an optical fiber lens 110 in which the ends of the first and second optical fibers 100a and 100b are integrally connected to each other and an end of which is formed of a lens surface 110a having a predetermined radius of curvature.

In this case, it is the easiest to use an arc-discharge method using a common fusion splicer. S183PM made by FITEL Company is used in the present invention as the heating means. However, aspects of the present invention are not limited thereto, and a method using a CO₂ laser and a heating method using an oxygen-hydrogen flame may also be used as the heating means.

Meanwhile, the most significant factor in manufacturing the paired optical fiber probe with a single body lens is to control heat caused by arc-discharge applied to the ends of the first and second optical fibers 100a and 100b. Since the radius of curvature of the lens surface 110a varies depending on the quantity of arc-discharge, focuses of two optical fibers 100a and 100b are changed. Thus, by controlling the arc-discharge condition, a paired optical fiber probe having a desired focal distance may be manufactured.

When an arc-discharge system is used in manufacturing a sample paired optical fiber probe having a focus of about 100 μm during the manufacturing of the paired optical fiber probe with a single body lens illustrated in FIG. 1, a model SM183PM manufactured by the FITEL company with the specification of an arc discharge power of 180 units and an arc-discharge duration time of 1600 ms was used.

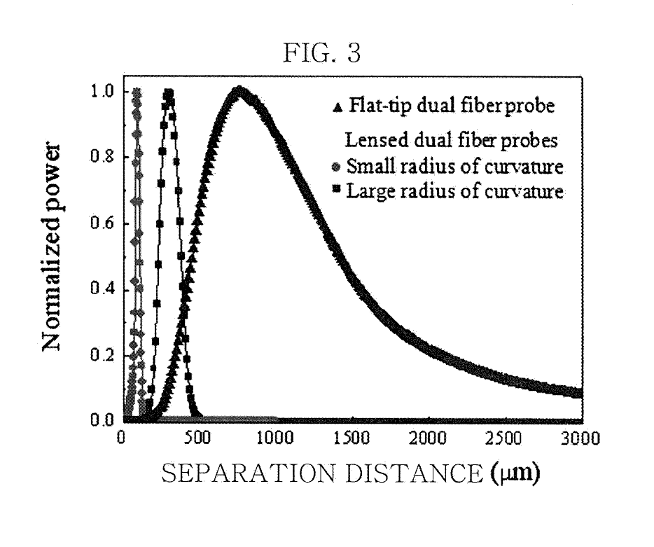

FIG. 3 is a graph showing the result of measuring a change in optical power according to a separation distance between a lens surface and a reflection mirror of a paired optical fiber probe with a single body lens according to an embodiment of the present invention. In detail, FIG. 3 is a graph showing the result of measuring focal distances of sample paired optical fiber probes (lensed dual fiber probe—small radius of curvature, large radius of curvature) that are manufactured to have focuses of about 100 μm and about 300 μm using a method for manufacturing a paired optical fiber probe with a single body lens according to an embodiment of the present invention. In the case of the sample paired optical fiber probes manufactured according to an embodiment of the present invention, only a signal in a very local region within about 0.2 mm can be measured from the focus of each paired optical fiber probe.

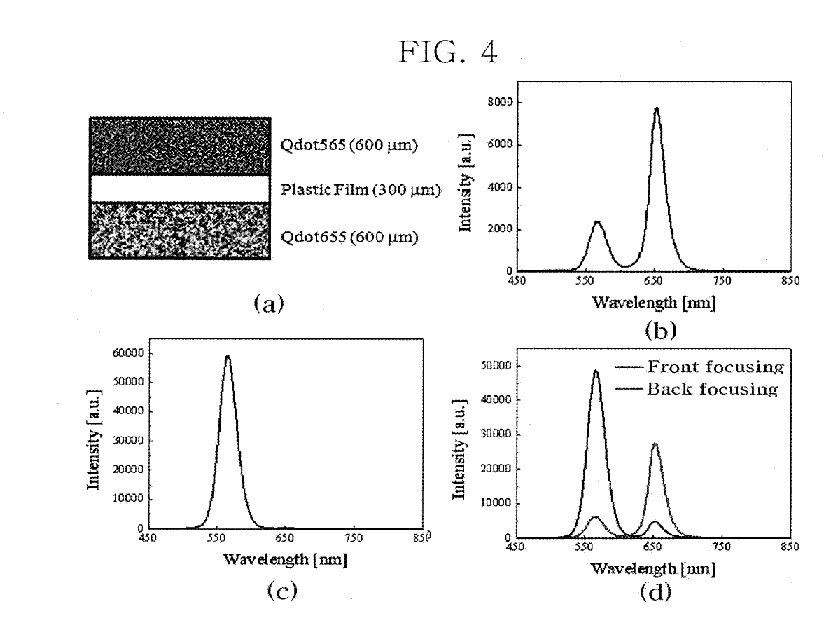

FIGS. 4A through 4D illustrate fluorescence signals measured using an arbitrarily manufactured sample and paired optical fiber probes with single body lenses manufactured according to an embodiment of the present invention. In detail, FIG. 4A illustrates an arbitrarily manufactured sample, FIG. 4B is a graph showing a fluorescence signal measured using a paired optical fiber probe having no lens, FIG. 4C is a graph showing a fluorescence signal measured using a paired optical fiber probe with a single body lens having a focus of about 100 μm according to the present invention, and FIG. 4D is a graph showing a fluorescence signal measured using a paired optical fiber probe with a single body lens having a focus of 300 μm according to the present invention.

Referring to FIGS. 4A through 4D, first, paired optical fiber probes with single body lenses manufactured according to an embodiment of the present invention have a high optical coupling efficiency compared to a general paired optical fiber probe having no lens. Also, since a signal can be obtained only in a very local region, the paired optical fiber probes with single body lenses may be utilized as probes capable of resolving depth.

In order to check this, phantoms including three layers having a particular thickness were manufactured. The phantoms were configured of a top layer having a thickness of 600 μm including Qdot565, a bottom layer having a thickness of 600 μm including Qdot655, and a plastic film having a thickness of 300 μm and inserted between the top layer and the bottom layer so as to differentiate the two layers from each other, as illustrated in FIG. 4A. Here, Qdot565 means minute particles or ‘quantum dots’ that give off fluorescence at 565 nm. Also, Qdot655 means minute particles or ‘quantum dots’ that give off fluorescence at 655 nm.

As a result of measurement, as illustrated in FIG. 4B, in the case of a paired optical fiber probe ‘Flat-tipped dual fiber probe’ having no lens, fluorescence signals generated in two layers were measured regardless of the position of the flat-tipped dual fiber probe.

That is, when a general paired optical fiber probe having no lens is used, it may not be known which fluorescence signal is generated in which layer when a fluorescence signal of a sample including two separate layers having different fluorescence characteristics is measured.

Meanwhile, as illustrated in FIG. 4C, when a paired optical fiber probe with a single body lens ‘Lensed dual fiber probe—small radius of curvature’ having a focus of about 100 μm according to the present invention was used, only a fluorescence signal generated from a surface layer of the manufactured sample could be selectively measured.

Also, as illustrated in FIG. 4D, when a paired optical fiber probe with a single body lens ‘Lensed dual fiber probe—large radius of curvature’ having a focus of about 300 μm according to the present invention was used, a distance from the manufactured sample to an end of the paired optical fiber probe was adjusted so that a fluorescence signal for front focusing generated from an upper layer of the manufactured sample, and a fluorescence signal for back focusing generated from a lower layer of the manufactured sample, could be effectively separated from each other.

As described above, it is expected that the paired optical fiber probe with a single body lens according to the present invention proposed from the experimental result may be utilized as a probe that is capable of resolving depth.

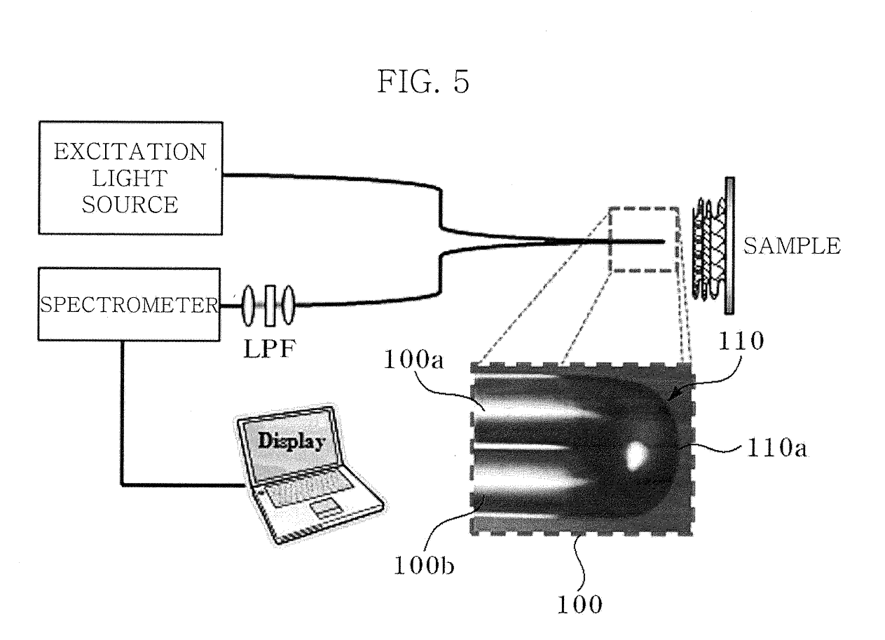

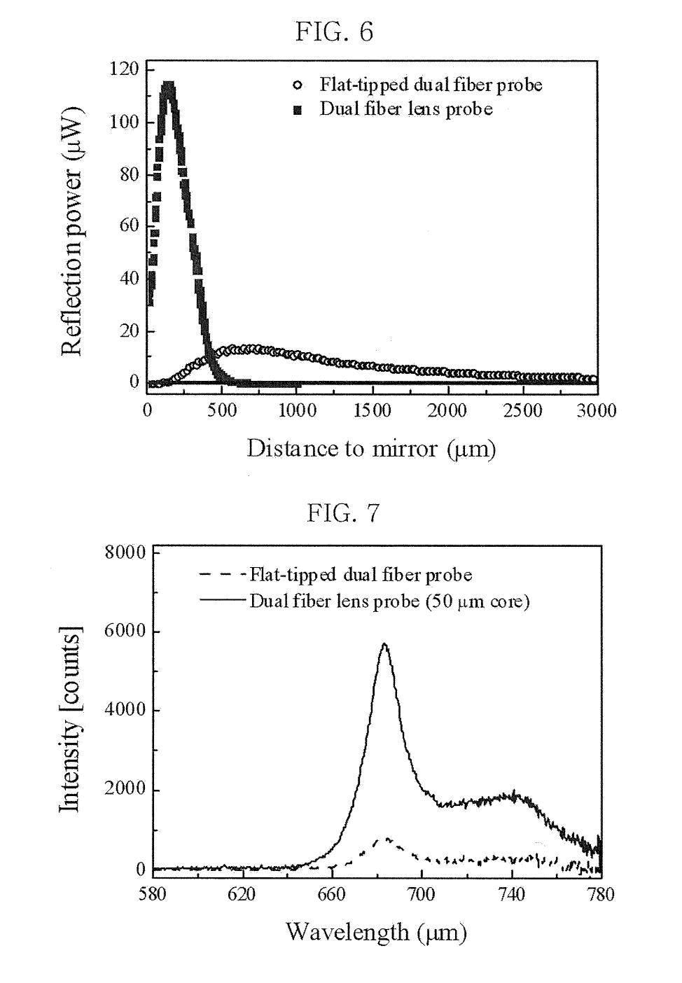

FIG. 5 is a view illustrating the concept of a fluorescence spectroscopic system for measuring a fluorescence signal from a sample using a paired optical fiber probe with a single body lens according to an embodiment of the present invention, FIG. 6 is a graph showing the result of comparing a paired optical fiber probe with a single body lens according to an embodiment of the present invention with a paired optical fiber probe having no lens with respect to a reflection signal measured from a mirror using the fluorescence spectroscopic system of FIG. 5, and FIG. 7 is a graph showing the result of comparing a paired optical fiber probe with a single body lens according to an embodiment of the present invention with a paired optical fiber probe having no lens with respect to a fluorescence signal measured from a ginkgo leaf using the fluorescence spectroscopic system of FIG. 5.

Referring to FIGS. 5 through 7, when the paired optical fiber probe with a single body lens according to an embodiment of the present invention is applied to the fluorescence spectroscopic system, the fluorescence spectroscopic system may be configured without using bulk elements as in the related art.

That is, the fluorescence spectroscopic system may include an excitation light source (a laser diode ‘Fiber pigtailed laser diode, 405 nm’), a paired optical fiber probe with a single body lens 100, a sample, a long-pass filter (LPF), a spectrometer, and a display device.

A fluorescence signal was measured from a well-known fluorescence sample using the fluorescence spectroscopic system having a simple configuration. In order to check the performance of the proposed paired optical fiber probe ‘Dual fiber lens probe’ with a single body lens according to the present invention, the results of comparing the ‘Dual fiber lens probe’ with a paired optical fiber probe ‘Flat-tipped dual fiber probe’ having no lens are shown in FIGS. 6 and 7.

As a result of comparison, it was measured that the ‘Dual fiber lens probe’ with a single body lens had an optical coupling efficiency that was about 6 times higher than the ‘Flat-tipped dual fiber probe’ having no lens. Also, in the case of the paired optical fiber probe ‘Flat-tipped dual fiber probe’ having no lens, a signal was measured in a wide region of about 2 mm or more, whereas, in the case of the paired optical fiber probe with a single body lens according to the present invention, a signal was measured only in a very local region within about 0.5 mm.

Thus, the proposed paired optical fiber probe with a single body lens according to the present invention can be utilized as a probe having a very high optical coupling efficiency and capable of resolving depth.

While the invention has been shown and described with reference to certain exemplary embodiments thereof, it will be understood by those skilled in the art that various changes in form and details may be made therein without departing from the spirit and scope of the invention as defined by the appended claims.

1. A paired optical fiber probe with a single lens body, comprising:
a first optical fiber;
a second optical fiber arranged in parallel with the first optical fiber; and
an optical fiber lens which is formed by heating a predetermined region including one end of the first optical fiber and one end of the second optical fiber using a heating means such that ends of the first and second optical fibers are integrally connected to each other, the optical lens having a lens surface with a predetermined radius of curvature.

2. The probe of claim 1, wherein the first and second optical fibers are arranged in such a way that portions of lateral sides of the first and second optical fibers are in line- or surface-contact with each other.

3. The probe of claim 2, wherein the first and second optical fibers are fixed by applying a predetermined adhesive to a portion in which the first and second optical fibers are arranged such that portions of lateral sides of the first and second optical fibers are in line- or surface-contact with each other.

4. The probe of claim 1, wherein the heating means is one selected from the group consisting of arc-discharge, an oxygen-hydrogen flame, and a CO₂ laser.

5. The probe of claim 1, wherein the first and second optical fibers have the same or different structures and are at least one selected from the group consisting of a single mode fiber (SMF), a multi-mode fiber (MMF), a photonic crystal fiber, and a double-cladding optical fiber.

6. A method for manufacturing a paired optical fiber probe, the method comprising:
(a) providing first and second optical fibers;
(b) arranging the first and second optical fibers in parallel with each other; and
(c) forming an optical fiber lens by heating a predetermined region including one end of the first optical fiber and one end of the second optical fiber using a heating means such that ends of the first and second optical fibers are integrally connected to each other, the optical lens having a lens surface with a predetermined radius of curvature.

7. The method of claim 6, wherein, in (b), the first and second optical fibers are arranged in parallel with each other in such a way that portions of lateral sides of the first and second optical fibers are in line- or surface-contact with each other.

8. The method of claim 7, further comprising fixing the first and second optical fibers by applying a predetermined adhesive to a portion in which the first and second optical fibers are arranged such that portions of lateral sides of the first and second optical fibers are in line- or surface-contact with each other.

9. The method of claim 8, further comprising, after fixing the first and second optical fibers, cleaving the first and second optical fibers in such a way that cross-sections of ends of the first and second optical fibers are parallel to each other.

10. The method of claim 6, wherein the heating means is one selected from the group consisting of arc-discharge, an oxygen-hydrogen flame, and a CO₂ laser.

11. The method of claim 6, wherein the first and second optical fibers have the same or different structures and are at least one selected from the group consisting of a single mode fiber (SMF), a multi-mode fiber (MMF), a photonic crystal fiber, and a double-cladding optical fiber.
